(19) United States
(12) Patent Application Publication
(10) Pub. No.: US 2007/0070888 A1
(43) Pub. Date: Mar. 29, 2007

(54) Method and apparatus to facilitate wireless access gateway selection

(75) Inventors: Sundar Raman, Chicago, IL (US); Michael Borella, Naperville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 11/238,186

(22) Filed: Sep. 29, 2005

(51) Int. Cl. H04L 12/26; H04B 1/16; H04L 1/00

(52) U.S. Cl. 370/229; 455/338

(57) ABSTRACT

A wireless access gateway (70) obtains (11) substantially current information regarding its own performance capacity. That information is communicated to a network element (90). In a preferred approach, the wireless access gateway integrally combines (12) the substantially current information with at least one call management message to provide a composite message, which composite message is then transmitted (14). The network element then preferably automatically makes determinations (82) regarding selection of a particular wireless access gateway to support a given call as a function, at least in part, of the substantially current information regarding wireless access gateway performance capacity.

### TECHNICAL FIELD

This invention relates generally to communication networks and more particularly to wireless access gateways and their selection to support a call.

### BACKGROUND

Communication networks of various kinds are known in the art. This includes communication networks that have a plurality of wireless access gateways (such as, but not limited to, Packet Data Serving Nodes, Gateway General Packet Radio Service Support Nodes, and so forth). Such wireless access gateways typically serve, at a minimum, to directly support one or more calls. In many networks such calls are allocated amongst candidate wireless access gateways by a corresponding network element (such as, but not limited to, a Packet Control Function, a Serving General Packet Radio Service Support Node, and so forth) (where it will be understood that, as used herein, “network element” refers both to a single integral platform as well as corresponding functionality that is distributed over a plurality of platforms, with such architectural options being known in the art).

Such an arrangement, though adequate for many purposes, nevertheless does pose some problems. For example, the network element may attempt to allocate calls based upon a wireless access gateway selection criteria or mechanism that can result in significantly overloading one wireless access gateway while leaving another wireless access gateway relatively lightly loaded. This can occur, for example, when the network element makes an initial selection decision based upon local information.

Another problem can arise in that the network element will typically not base selection of a particular wireless access gateway upon the type of call that requires support. Different kinds of calls have differing corresponding required (or desired) quality of service standards. As network elements often ignore such distinctions, it is possible that a call requiring a particular quality of service level may be initially allocated to a wireless access gateway that cannot, in fact, reliably provide that level of quality of service.

Such problems can result in dropped or refused calls. This, in turn, can detrimentally impact the user experience.

### BRIEF DESCRIPTION OF THE DRAWINGS

The above needs are at least partially met through provision of the method and apparatus to facilitate wireless access gateway selection described in the following detailed description, particularly when studied in conjunction with the drawings, wherein:

FIG. 1 comprises a flow diagram as configured in accordance with various embodiments of the invention;

FIG. 2 comprises a schematic view of a message format as configured in accordance with the prior art;

FIG. 3 comprises a schematic view of a message format as configured in accordance with various embodiments of the invention;

FIG. 4 comprises an example schematic view of a usage statistics container message format as configured in accordance with various embodiments of the invention;

FIG. 5 comprises an example schematic view of a useage statistics data entry message format as configured in accordance with various embodiments of the invention;

FIG. 6 comprises an example schematic view of example data instances;

FIG. 7 comprises a block diagram as configured in accordance with various embodiments of the invention;

FIG. 8 comprises a flow diagram as configured in accordance with various embodiments of the invention; and

FIG. 9 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a wireless access gateway can obtain substantially current information regarding its own performance capacity (where “substantially current” shall be understood to refer to current, historical, or even relatively near-term future where predictions of performance capacity can be relatively reliably ascertained). That information can then be communicated to a network element. In a preferred approach, the wireless access gateway integrally combines the substantially current information with at least one call management message to provide a composite message, which composite message is then transmitted. By one approach the network element receives this transmission. By another approach, if desired, an intermediary platform (such as a corresponding server) can receive this message and then convey its substantive content to the network element on a push or pull basis as desired.

In turn, the network element will preferably receive this content and hence obtain the substantially current information regarding the performance capacity of the wireless access gateway. In a preferred approach, this network element will receive similar information for a plurality of such wireless access gateways. The network element then preferably automatically makes determinations regarding selection of a particular wireless access gateway to use to support a given call as a function, at least in part, of the substantially current information regarding wireless access gateway performance capacity.

So configured, the network element is then able to make informed selection decisions. In particular, the network element can make wireless access gateway selections that serve, for example, to effect a load leveling strategy. This, in turn, would aid in avoiding having one wireless access gateway become overburdened while another remains considerably less tasked. As another example, the network element can now make call support decisions that take quality of service requirements into account. This could be accomplished, for example, by selecting wireless access gateways that appear to have suitable available support resources to support corresponding calls while avoiding wireless access gateways that appear to lack present requisite (or adequate) bandwidth resources for a given call having higher quality of service requirements.

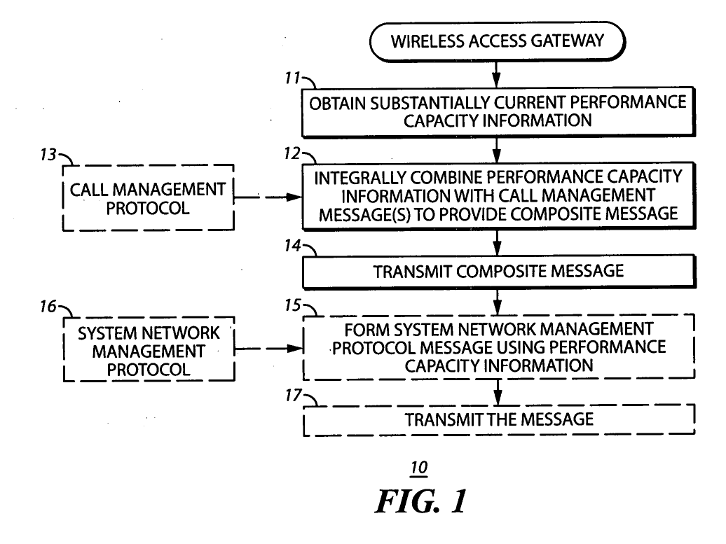

These and other benefits may become clearer upon making a thorough review and study of the following detailed description. Referring now to the drawings, and in particular to FIG. 1, an illustrative process 10 to be preferably implemented by a wireless access gateway (such as, but not limited to, a Packet Data Serving Node, a Gateway General Packet Radio Service Support Node, and so forth) will be described.

Pursuant to this process 10, the wireless access gateway obtains 11 substantially current information regarding its own performance capacity. This information can comprise essentially any load and/or performance related information including, but not limited to, the following examples:
wireless access gateway processing platform utilization;
wireless access gateway throughput;
wireless access gateway memory utilization;
wireless access gateway call events per a given unit of time;
wireless access gateway message header compression ratios;
a presently supported number of calls;
a presently supported number of calls per type of call;
quality of service indications per user;
a number of quality of service limits that have been exceeded by users; and
a number of packet filters;
   to name a few.

Those skilled in the art will recognize that various means already exist by which a wireless access gateway can ascertain such information and additional relevant parameters (and means of ascertaining such parameters) will likely be identified and developed in the future. As these teachings are not particularly sensitive to the selection of any particular means of ascertaining such information, and for the sake of brevity and the preservation of narrative focus, additional details regarding the obtaining of specific performance capacity-related information will not be presented here.

In a preferred though optional step, this process 10 then provides for integrally combining 12 such substantially current information with at least one call management message to thereby provide a resultant composite message. As used herein, “call management message” shall be understood to refer to messages, such as messages that are formatted and defined in accordance with a corresponding call management protocol 13, that are designed and intended to directly facilitate the assignment, maintenance, and/or termination of calls. Accordingly, such information can be combined with, for example, a call establishment message, a call termination message, or a call maintenance message, to name but a few.

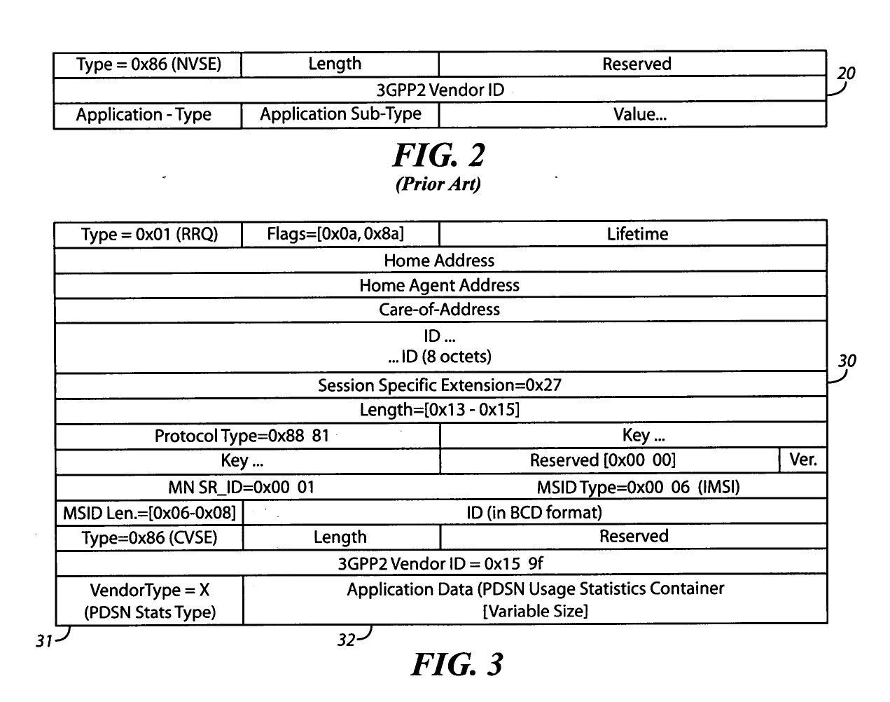

Various such call management messages are presently known and others will likely be developed in the future. One present example of a call management protocol is the A11 protocol. The A11 protocol makes specific provision for Vendor Specific Extensions that can be employed as described to accommodate performance capacity-related information. To illustrate, and referring momentarily to FIG. 2, a so-called Normal Vendor Specific Extension format 20 provides space and opportunity to present such information via fields intended for application types, application sub-types, and corresponding values.

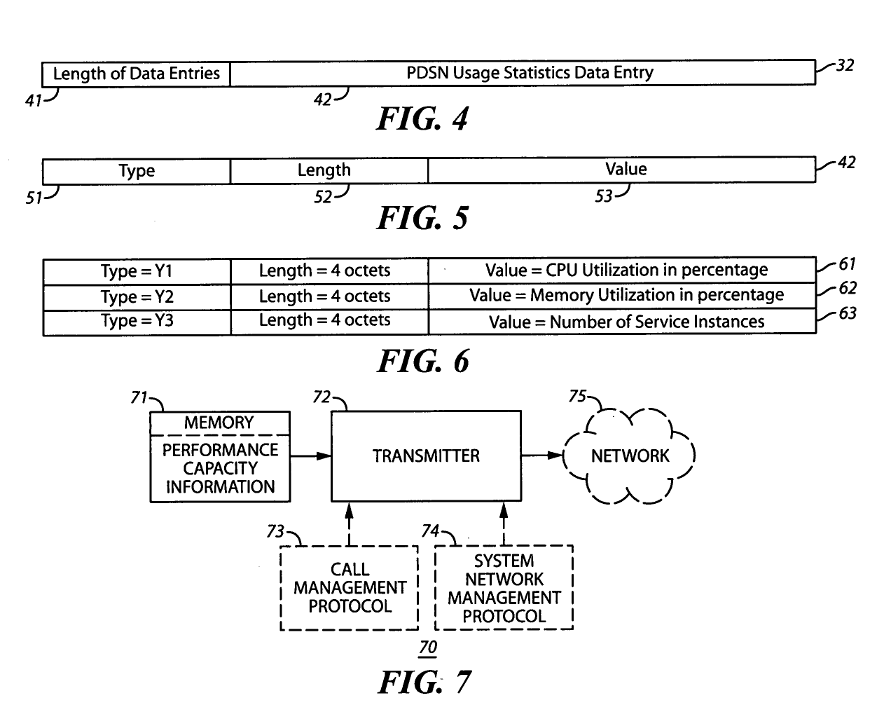

Referring now momentarily to FIG. 3, a relevant portion of an illustrative Normal Vendor Specific Extension format 30 (defined using presently understood 3GPP2 values as are known in the art) is shown in schematic form. This message contains, in this illustrative example, a vendor type indicator 31 and a Usage Statistics Container 32. The latter can serve to represent the kinds of performance capacity-related statistics that are described above. To illustrate this point, and referring now to FIG. 4, the Usage Statistics Container 32 can comprise an indication 41 regarding the length of data entries (to thereby define, for example, the total size of the Usage Statistics Data Entry fields) and instances 42 (one being shown) of corresponding Usage Statistics Data entries. As noted, a plurality of such instances 42 may be provided with each such instances preferably representing each usage parameter of interest.

With reference to FIG. 5, each such instance 42 may comprise, for example, a type field 51 (to define the different values that may be used to specify each such usage statistic), a length field 52 (to define the length, for example, of the type/length/value (TLV) combination in octets), and a value field 53 (to store, for example, the actual value of the specific statistic being reported. Examples of entries using such a format are presented in FIG. 6 where a first instance 61 provides such information regarding central processing unit utilization, a second instance 62 provides such information regarding memory utilization, and a third instance 63 provides such information regarding a number of service instances.

It will be understood and appreciated that such information can be formatted in any of a variety of different ways. For example, each statistic may be set forth as a separate application type or as a separate application sub-type. It would also be possible, for example, to use a predefined format to express such data. It will also be understood and appreciated that such information can be expressed using a type-length-value scheme as is known in the art, as a binary large object (often denoted as a BLOB) (i.e., a series of bits that are to be interpreted in a proprietary manner), or by using such other mode of expression as may suit the needs and requirements of a given application setting.

Referring again to FIG. 1, this process 10 then provides for transmitting 14 the message (such as, for example, the composite message described above) that contains the performance capacity information. This transmission may be achieved using any transport medium of choice as will be well understood by those skilled in the art. In a preferred embodiment this transmission may be addressed to a network element (such as, but not limited to, a Packet Control Function) that will make use of the information as described herein. If desired, however, this transmission may instead (or also) serve to convey the information to one or more intermediary platforms that serve to collect such information on behalf of such a network element.

As alluded to above, some wireless access gateway statistics are already collected by some wireless access gateways. Such collected information is then often conveyed to a platform of interest using, for example, a System Network Management Protocol (SNMP) which, unlike a call management protocol, serves exactly for such a purpose. If desired, the above-described process 10 can be supplemented with an additional step of forming 15 a System Network Management Protocol message using some or all of the previously described substantially current information (using, for example, a corresponding System Network Management Protocol 16 of choice). This System Network Management Protocol message can then be transmitted 17 to a target platform of choice.

So configured, those skilled in the art will readily understand and appreciate that such a wireless access gateway is readily able to develop and transfer information regarding its present performance capacity to another network element. Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 7, an illustrative approach to such a platform will be provided.

In this illustrative embodiment, the wireless access gateway 70 comprises a memory 71. This memory 71 preferably has stored therein the substantially current information regarding performance capacity for the wireless access gateway as has been described above. (Those skilled in the art will recognize that this memory 71 may comprise a single storage platform as is suggested by the illustration but may also comprise a distributed platform that comprises two or more physically distinct storage entities.)

The memory 71 operably couples to a transmitter 72 to thereby facilitate the above-described transmission of the performance capacity information (via, for example, a communication network 75 of choice). As described above, this transmission may optionally comprise a call management message (as accords with the requirements of a corresponding call management protocol 73) having the performance capacity content integrally contained therein. As is also described above, it may further be desirable to provide a System Network Management Protocol 74 such that the transmitter 72 may also optionally and supplementally provide performance capacity content to other targets of choice (as may be useful to support other needs and requirements, for example).

Those skilled in the art will recognize and understand that such a wireless access gateway 70 may be comprised of a plurality of physically distinct elements as is suggested by the illustration shown in FIG. 7. It is also possible, however, to view this illustration as comprising a logical view, in which case one or more of these elements can be enabled and realized via a shared platform. It will also be understood that such a shared platform may comprise a wholly or at least partially programmable platform as are known in the art.

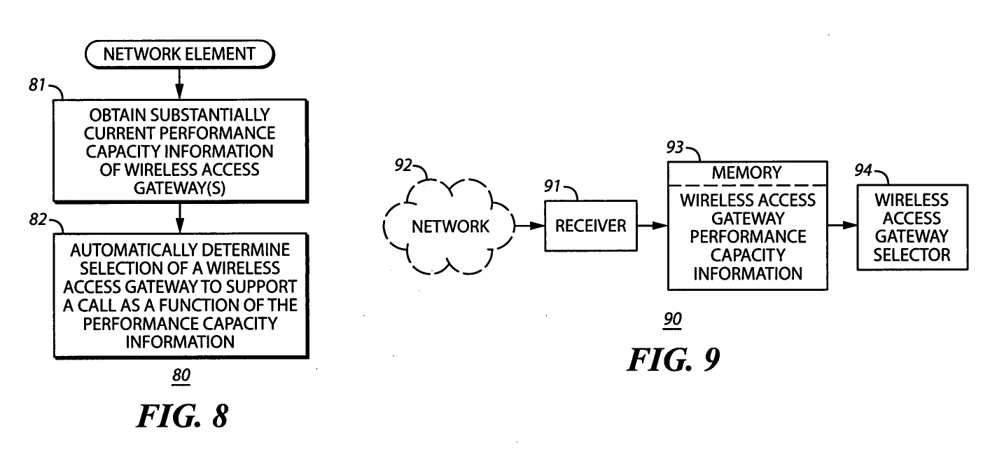

As described above, the wireless access gateway provides information regarding its performance capacity to a network element such as a Packet Control Function. Referring now to FIG. 8 an illustrative corresponding network element process 80 will be described.

The network element process 80 provides for obtaining 81 the substantially current information regarding the performance capacity of one or more wireless access gateways. The information can be obtained 81, for example, by reception of a transmitted message such as those described above. As a particular (though optional and non-exhaustive) illustration, the network element can receive a call management message that comprises as an integral part thereof the performance capacity information as characterizes a corresponding wireless access gateway.

This network element process 80 then provides for automatically making a determination 82 regarding selecting a particular wireless access gateway to use to support a given call as a function, at least in part, of the substantially current information regarding the performance capacity of that (and likely and preferably other) wireless access gateway(s). The particular nature of the selection determination can and will vary with the needs and requirements of a given application setting. Examples include, but are not limited to:
Selecting a particular wireless access gateway to support the call;
Not selecting any wireless access gateway to support the call;
Facilitating having one or more wireless access control gateways drop at least one of their other existing calls (this approach may be used, for example, to facilitate freeing up resources that can then be employed in favor of a new call that might have a higher priority and/or higher quality of service requirements);
   to name a few.

So configured, those skilled in the art will readily understand and appreciate that such a network element is readily able to receive and utilize information regarding the substantially present performance capacity of a plurality of wireless access gateways. Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 9, an illustrative approach to such a platform will be provided.

This illustrative network element 90 (which may comprise, for example, a Packet Control Function) comprises a receiver 91 that is configured and arranged to compatibly receive (via, for example, a network 92 of choice) messages from wireless access gateways (or other intermediary sources) as has been described above. The receiver 91 operably couples to a memory 93 that serves in a preferred embodiment to store and retain at least some of the received substantially current information regarding performance capacity for the above-mentioned wireless access gateways. This memory 93, in turn, operably couples to a wireless access gateway selector 94.

The wireless access gateway selector 94 is configured and arranged (via, for example, appropriate programming) to automatically make a determination regarding selecting a particular wireless access gateway to support corresponding calls as a function, at least in part, of the stored substantially current information regarding performance capacity of at least some of those wireless access gateways.

Those skilled in the art will recognize and understand that such a network element 90 may be comprised of a plurality of physically distinct elements as is suggested by the illustration shown in FIG. 9. It is also possible, however, to view this illustration as comprising a logical view, in which case one or more of these elements can be enabled and realized via a shared platform. It will also be understood that such a shared platform may comprise a wholly or at least partially programmable platform as are known in the art. And it will also be understood that the described functionality may also be distributed over a plurality of supporting platforms if so desired.

So configured, these teachings facilitate the development of performance capacity information for one or more of a plurality of wireless access gateways and the transfer of that information to a network element that can then utilize that information to inform the subsequent selection of specific wireless access gateways to support calls. This capability can then be leveraged and applied as desired to achieve any of a wide variety of beneficial results including improved overall call throughput, reduced call establishment latency, reduced premature call drops, improved quality of service for at least some calls, and so forth.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a network element:
obtaining substantially current information regarding performance capacity of a wireless access gateway;
automatically making a determination regarding selecting the wireless access gateway to support a call as a function, at least in part, of the substantially current information regarding performance capacity of the wireless access gateway.

2. The method of claim 1 wherein the network element comprises a Packet Control Function.

3. The method of claim 1 wherein the wireless access gateway comprises a Packet Data Serving Node.

4. The method of claim 1 wherein the substantially current information comprises information regarding at least one of:
wireless access gateway processing platform utilization;
wireless access gateway throughput;
wireless access gateway memory utilization;
wireless access gateway call events per a given unit of time;
wireless access gateway message header compression ratios;
a presently supported number of calls;
a presently supported number of calls per type of call;
quality of service indications per user;
a number of quality of service limits that have been exceeded by users;
a number of packet filters.

5. The method of claim 1 wherein obtaining substantially current information comprises receiving the substantially current information as a part of call management message.

6. The method of claim 5 wherein the call management message comprises at least one of:
a call establishment message;
a call termination message;
a call maintenance message.

7. The method of claim 5 wherein the call management message comprises an A11-compatible call management message.

8. The method of claim 1 wherein automatically making a determination regarding selecting the wireless access gateway to support a call comprises at least one of:
selecting the wireless access gateway to support the call;
selecting a different wireless access gateway to support the call;
not selecting any wireless access gateway to support the call;
facilitating having the wireless access gateway dropping at least one other call.

9. The method of claim 1 wherein:
obtaining substantially current information regarding performance capacity of a wireless access gateway comprises obtaining substantially current information regarding performance capacity of a plurality of wireless access gateways; and
automatically making a determination regarding selecting the wireless access gateway to support a call as a function, at least in part, of the substantially current information regarding performance capacity of the wireless access gateway comprises automatically making a determination regarding selecting a particular wireless access gateway to support a call as a function, at least in part, of the substantially current information regarding performance capacity of the plurality of wireless access gateways.

10. A network element comprising:
a receiver;
a memory operably coupled to the receiver and having substantially current information regarding performance capacity of a wireless access gateway stored therein;
a wireless access gateway selector operably coupled to the memory and being configured and arranged to automatically make a determination regarding selecting the wireless access gateway to support a call as a function, at least in part, of the substantially current information regarding performance capacity of the wireless access gateway.

11. The network element of claim 10 wherein the network element comprises a Packet Control Function.

12. The network element of claim 10 wherein the substantially current information comprises information regarding at least one of:
wireless access gateway processing platform utilization;
wireless access gateway throughput;
wireless access gateway memory utilization;
wireless access gateway call events per a given unit of time;
wireless access gateway message header compression ratios;
a presently supported number of calls;
a presently supported number of calls per type of call;
quality of service indications per user;
a number of quality of service limits that have been exceeded by users;
a number of packet filters.

13. The network element of claim 10 wherein the wireless access gateway selector further comprises means for automatically making a determination regarding selecting the wireless access gateway to support a call as a function, at least in part, of the substantially current information regarding performance capacity of the wireless access gateway.

14. The network element of claim 10 wherein the memory has substantially current information regarding performance capacity of a plurality of wireless access gateways stored therein.

15. A method comprising:
at a wireless access gateway:
obtaining substantially current information regarding performance capacity of the wireless access gateway;
integrally combining the substantially current information with at least one call management message to provide a composite message;
transmitting the composite message.

16. The method of claim 15 wherein the wireless access gateway comprises a Packet Data Serving Node.

17. The method of claim 15 wherein the substantially current information comprises information regarding at least one of:
wireless access gateway processing platform utilization;
wireless access gateway throughput;
wireless access gateway memory utilization;
wireless access gateway call events per a given unit of time;
wireless access gateway message header compression ratios;
a presently supported number of calls;
a presently supported number of calls per type of call;
quality of service indications per user;
a number of quality of service limits that have been exceeded by users;
a number of packet filters.

18. The method of claim 15 wherein integrally combining the substantially current information with at least one call management message comprises integrally combining the substantially current information with at least one call management message comprising at least one of:
a call establishment message;
a call termination message;
a call maintenance message.

19. The method of claim 15 wherein integrally combining the substantially current information with at least one call management message comprises integrally combining the substantially current information with an A11-compatible call management message.

20. The method of claim 15 wherein transmitting the composite message comprises transmitting the composite message to a Packet Control Function.

21. The method of claim 15 further comprising:
forming a System Network Management Protocol message using the substantially current information;
transmitting the System Network Management Protocol message.

22. A wireless access gateway comprising:
a memory operably having substantially current information regarding performance capacity of the wireless access gateway stored therein;
a transmitter operably coupled to the memory and being configured and arranged to transmit a call management message that contains at least some of the substantially current information regarding performance capacity of the wireless access gateway.

23. The wireless access gateway of claim 22 wherein the substantially current information comprises information regarding at least one of:
wireless access gateway processing platform utilization;
wireless access gateway throughput;
wireless access gateway memory utilization;
wireless access gateway call events per a given unit of time;
wireless access gateway message header compression ratios;
a presently supported number of calls;
a presently supported number of calls per type of call;
quality of service indications per user;
a number of quality of service limits that have been exceeded by users;
a number of packet filters.

24. The wireless access gateway of claim 22 wherein the call management message comprises at least one of:
a call establishment message;
a call termination message;
a call maintenance message.

25. The wireless access gateway of claim 22 wherein the call management message comprises an A11-compatible call management message.

26. A method comprising:
at a wireless access gateway:
obtaining substantially current information regarding performance capacity of the wireless access gateway;
integrally combining the substantially current information with at least one call management message to provide a composite message;
transmitting the composite message;
at a network element:
recovering the substantially current information regarding performance capacity of the wireless access gateway from content that corresponds to the composite message;
automatically making a determination regarding selecting the wireless access gateway to support a call as a function, at least in part, of the substantially current information regarding performance capacity of the wireless access gateway.

27. The method of claim 26 wherein the wireless access gateway comprises a Packet Data Serving Node and the network element comprises a Packet Control Function.
